(19) United States
(12) Patent Application Publication
(10) Pub. No.: US 2021/0042038 A1
(43) Pub. Date: Feb. 11, 2021

(54) TECHNIQUES TO IDENTIFY SEGMENTS OF INFORMATION SPACE THROUGH ACTIVE ADAPTION TO ENVIRONMENT CONTEXT

(71) Applicant: International Business Machines Corporation, Armonk, NY (US)

(72) Inventors: Oleg Sidorkin, BALASHIKHA (RF); Sergey Batin, BALASHIKHA (RF); MICHAEL BORDASH, NEWTOWN, CT (US)

(21) Appl. No.: 16/533,964

(22) Filed: Aug. 7, 2019

(51) Int. Cl. G06F 3/06; G06N 5/04

(52) U.S. Cl. CPC G06F 3/0611; G06F 3/0659; G06F 3/0685; G06N 5/04

(57) ABSTRACT

Techniques to identify segments of information space through active adaption of environment context are provided. A first user request is received by an artificial intelligence (AI) system, and a first segment of information is retrieved from a heterogeneous storage medium, where the first segment of information is located in an upper layer of the heterogeneous storage medium. Upon determining that the first segment of information does not resolve the first user request, the first segment of information is sunk to a relatively lower layer of the heterogeneous storage medium, a second segment of information is retrieved from the relatively lower layer of the heterogeneous storage medium, and upon determining that the second segment of information resolves the first user request, the second segment of information is surfaced to the upper layer of the heterogeneous storage medium.

### BACKGROUND

The present disclosure relates to information spaces, and more specifically, to utilizing active adaption to identify relevant segments of an information space.

In order to accurately function, modern computing systems (particularly information retrieval systems or artificial intelligent systems) require large amounts of stored data. Additionally, this data must be stored in a way that enables the system to identify and retrieve relevant information at any given time. Maintaining larger data stores improves the probability that accurate, adequate, or satisfactory data will be returned for any given input. However, as data stores grow increasingly larger, storage costs can become significant. That is, the monetary costs increase, as well as the processing costs required to search increasingly larger stores. Further, storage solutions capable of maintaining this large amount of data are often slow to access, introducing additional latency to the system.

### SUMMARY

According to one embodiment of the present disclosure, a method is provided. The method includes receiving, by an artificial intelligence (AI) system, a first user request. The method further includes retrieving a first segment of information from a heterogeneous storage medium, wherein the first segment of information is located in an upper layer of the heterogeneous storage medium. Upon determining that the first segment of information does not resolve the first user request, the method includes sinking the first segment of information to a relatively lower layer of the heterogeneous storage medium, and retrieving a second segment of information from the relatively lower layer of the heterogeneous storage medium. Further, upon determining that the second segment of information resolves the first user request, the method includes surfacing the second segment of information to the upper layer of the heterogeneous storage medium.

According to a second embodiment of the present disclosure, a computer-readable storage medium is provided. The computer-readable storage medium has computer-readable program code embodied therewith, the computer-readable program code executable by one or more computer processors to perform an operation. The operation includes receiving, by an artificial intelligence (AI) system, a first user request. The operation further includes retrieving a first segment of information from a heterogeneous storage medium, wherein the first segment of information is located in an upper layer of the heterogeneous storage medium. Upon determining that the first segment of information does not resolve the first user request, the operation includes sinking the first segment of information to a relatively lower layer of the heterogeneous storage medium, and retrieving a second segment of information from the relatively lower layer of the heterogeneous storage medium. Further, upon determining that the second segment of information resolves the first user request, the operation includes surfacing the second segment of information to the upper layer of the heterogeneous storage medium.

According to a third embodiment of the present disclosure, a system is provided. The system includes one or more computer processors, and a memory containing a program which when executed by the one or more computer processors performs an operation. The operation includes receiving, by an artificial intelligence (AI) system, a first user request. The operation further includes retrieving a first segment of information from a heterogeneous storage medium, wherein the first segment of information is located in an upper layer of the heterogeneous storage medium. Upon determining that the first segment of information does not resolve the first user request, the operation includes sinking the first segment of information to a relatively lower layer of the heterogeneous storage medium, and retrieving a second segment of information from the relatively lower layer of the heterogeneous storage medium. Further, upon determining that the second segment of information resolves the first user request, the operation includes surfacing the second segment of information to the upper layer of the heterogeneous storage medium.

### BRIEF DESCRIPTION OF THE SEVERAL VIEWS OF THE DRAWINGS

FIG. 1 illustrates a workflow for actively identifying relevant information segments in an information space, according to one embodiment disclosed herein.

FIGS. 2A and 2B illustrate techniques to surface and sink relevant information segments to improve efficiency, according to one embodiment disclosed herein.

FIG. 3 is a block diagram illustrating an AI system configured to identify relevant information segments using active adaptation based on environmental context, according to one embodiment disclosed herein.

FIG. 4 is a flow diagram illustrating a method for actively identifying relevant information segments, according to one embodiment disclosed herein.

FIG. 5 is a flow diagram illustrating a method for profiling user contexts in an actively-adapting information system, according to one embodiment disclosed herein.

FIG. 6 is a flow diagram illustrating a method for identifying relevant information segments, according to one embodiment disclosed herein.

### DETAILED DESCRIPTION

Embodiments of the present disclosure provide techniques to actively surface and sink information in an information space, in order to better identify relevant data in an efficient and cost-effective manner. In embodiments, information analysis and retrieval systems maintain large (and often ever-growing) information spaces that can be queried for relevant information. For example, an artificial intelligence (AI) application may rely on such a system in order to identify relevant data for a given request or input, and generate an appropriate response. In some embodiments of the present disclosure, the information space is maintained as a graph of elements or entities, linked by relationships between these elements.

In one embodiment, as the system interacts with the information space, relationships between entities can be created, removed, or modified (e.g., by increasing or decreasing the weight or relevance of the relationship). In some embodiments, segments and branches of the information space are further annotated based on quantitative observations of the environment context, as well as qualitative feedback from users. Additionally, in an embodiment, the information space is constantly growing, as new data is learned and ingested during operations. For example, in one embodiment, inputs and requests from users can be added to the information space, such that it can be retrieved and relied on subsequently to better respond to future requests. In this way, the system is dynamic and intelligent. For a given input (e.g., a request from a user), the information system should identify and retrieve relevant data to generate a response.

In embodiments, however, the information space can present significant storage concerns. Typically, storage solutions can vary drastically in price, capacity, and speed. For example, serialized storage may be faster than deserialized storage, but at increased costs (or decreased size). Similarly, random access memory (RAM) or a cache can be relatively faster than disk-based storage, but with reduced capacity and increased price. Further, remote storage solutions (such as in the cloud) may provide significant capacity and ease of expansion, but with significantly increased latency. In embodiments of the present disclosure, the continuous information space, represented as a graph, is stored in a heterogeneous storage solution that includes a number of layers, where each layer is associated with varying advantages and disadvantages. In one embodiment, relatively higher layers are associated with reduced access cost, such as latency to use (e.g., to search for and retrieve data), while relatively lower layers involve additional time or costs to utilize.

In one embodiment, in order to provide accurate and reliable responses, the system utilizes adaptation to actively surface and sink segments of the information space during use, such that the most relevant information for a given question is more likely to be found in a relatively higher layer of the heterogeneous storage solution. In some embodiments, if a segment of the information space is identified and utilized based on particular input, that data is surfaced to a relatively higher layer of the storage system. Similarly, as data is used less frequently, it is progressively sunk to lower layers of the system. In this way, relevant data for a given context is actively moved in the heterogeneous storage system in order to improve computing efficiency. That is, the next time the given context arises, the relevant data in the information space will be located in a relatively higher layer of the system which reduces the cost to access it. In embodiments, the context can include any number of system factors, such as the current input, previous inputs/requests, the current user, the time of day, and the like.

In an embodiment, each request or input is a question or inquiry to be answered (or otherwise fulfilled) by searching the information space. For example, a user may request information, instruct a task or operation to be performed, and the like. In one embodiment, the system queries the storage system to respond to requests, utilizing relatively higher layers of the storage system first, before proceeding to lower layers (if the request is not yet resolved). In some embodiments, the system determines whether to continue to lower (and therefore, more expensive) storage layers based on a confidence level associated with the current “best” response. For example, the system may identify data in the highest layer and evaluate it to determine a confidence that it adequately fulfills the request. If the confidence is above a predefined threshold, the data can be used to return a response. If the confidence is below a threshold, however, the system can search the next-lowest layer of the storage, and so on until a satisfactory response is found.

In some embodiments, the request can further specify a cost or importance of the request. In one embodiment, a cost limit (or low importance) can restrict the storage system from searching too deep in the system. Similarly, a higher cost limit (or a higher importance) can instruct the system to continue searching further/deeper in the system until a higher-confidence response can be generated. In an embodiment, to identify relevant data to response to a request, the system utilizes a combination of the relationship strength between entities, as well as the layer each entity resides in. For example, the system may identify a first relevant entity (e.g., a node in the storage graph), and identify other entities (e.g., nodes) that are connected to the first node (e.g., via an edge in the graph) with a predefined minimum weight. The system may then retrieve and evaluate the data in each identified element, based on the strength of the relationship and/or the layer the element is stored in.

In such an embodiment, for example, the system may first evaluate data with stronger connections, but defer evaluating elements that are stored in lower layers of the storage system (even if the connection is strong). In some embodiments, the system holistically determines whether to retrieve the data in a lower layer, based on the strength of the connection and the cost of the retrieval (e.g., the layer it is in). In another embodiment, the system searches the highest layer first, and only proceeds to the next-lower layer once the upper layer has been exhausted without identifying adequate data. In this way, the system can iteratively traverse the graph (reaching progressively more remote nodes and/or progressively lower-layers of storage) until a satisfactory response can be returned.

In one embodiment, individual user contexts can be profiled as well. That is, statistics (such as time and/or cost to generate responses, accuracy and/or confidence of the responses, and the like) can be collected on a per-user basis, in order to identify the top-performing profiles (e.g., the most efficient and/or accurate ones). These can be continuously merged into the lower-preforming profiles in order to improve overall performance of the system. In some embodiments, the top-performing profiles are also used to train or guide newer users of the system, in order to reduce the learning curve and shorten the time required for the AI system to adapt to a new user context.

For example, in one embodiment, user behavior can be influenced by next-step recommendations generated by the system. That is, the system may identify relevant data and/or respond to requests based in part on the previously-profiled top performers, which can improve efficiency and reduce response time and cost for newer users. In one embodiment, the profiles consist of a ranking of entities and/or corresponding relationships between entities. These rankings are therefore easily mergeable and transferrable, to improve the efficiency of the system overall. In an embodiment, these rankings are learned as the user utilizes the system. For example, in some embodiments, the AI system can infer the relationships based on the user's next request, or the user may specifically indicate the quality of the response.

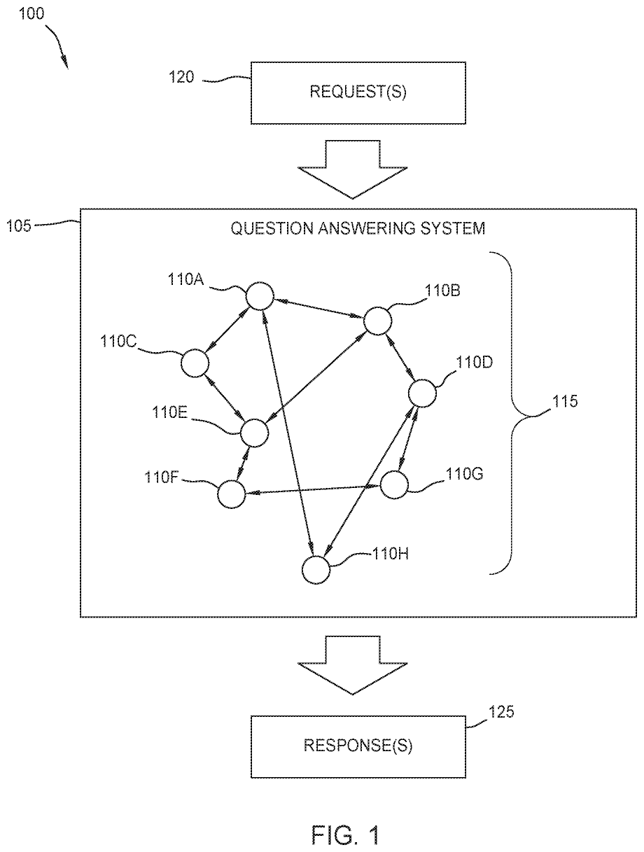

FIG. 1 illustrates a workflow 100 for actively identifying relevant information segments in an information space, according to one embodiment disclosed herein. As illustrated, a Question Answering System 105 (e.g., an AI system) receives Requests 120 from one or more users, and generates corresponding Responses 125. In some embodiments, the Requests 120 and Responses 125 are natural language and conversational. In some embodiments, the Requests 120 and Responses 125 are received and returned sequentially, as if the user is having a conversation with the Question Answering System 105. For example, a first Request 120 may include “show me the top five mailings we sent last year,” and the correspond Response 125 may include “here are the top five mailings from last year” followed by a list of the mailings.

In some embodiments, the system maintains some or all of the previous Requests 120 and Responses 125 from a given user as the context of the current Request 120 from the user, and uses the context to generate the next Response 125. Continuing the above example, after a period of time, the user may request “what is the average open rate of those mailings.” If the Question Answering System 105 has maintained this context, it may be able to generate an appropriate Response 125 (such as “the average open rate of those top five mailings from last year is X %”). In another embodiment, if the Question Answering System 105 cannot confidently determine which mailings the user is referring to, the Response 125 may request more information (e.g., “What mailings are you referring to?”).

In the illustrated embodiment, the Question Answering System 105 utilizes an information space organized as a Graph 115 in order to generate Responses 125. As illustrated, the Graph 115 includes a number of entities or Elements 110A-H, linked by connections or edges. In some embodiments, the connections between any given Elements 110 can be bidirectional or unidirectional, depending on the nature of the relationship. In other embodiments, all connections are bidirectional. In one embodiment, the distance between any two Elements 110 in the Graph 115 is defined based on the number of edges or links needed to be traversed to get from the first Element 110 to the second. In some embodiments, each edge can have a corresponding weight or strength, indicating the strength of the relationship between the corresponding Elements 110. As depicted, the Graph 115 represents a continuous information space where relevant data may be located in any Element 110.

In some embodiments, as the Question Answering System 105 interacts with users, the information space grows (e.g., new Elements 110 are created and connected, new data is added to existing Elements 110, and/or connections are created, removed, or modified). In an embodiment, the Graph 115 is stored in a heterogeneous storage system that has a number of layers, where each layer is associated with a corresponding access cost (e.g., in terms of computing resources or time required to access data maintained in the layer). A given Element 110 may reside in any storage layer, and may have connections (e.g., pointers) to other Elements 110, which may reside in the same layer or in a different layer. In one embodiment, as the Question Answering System 105 is used, Elements 110 in the Graph 115 are continuously migrated based on their relevance for a given context.

For example, if Element 110G is used to respond to a Request 120, the Element 110G may be moved from the layer it resides in to a relatively higher layer. That is, the data used to fulfill the Request 120 can be stored in a relatively higher layer than where it was previously located. In this way, when the same (or a similar) context arises, the Question Answering System 105 can identify and retrieve this data more efficiently, and with increased probability. Similarly, in an embodiment, as upper layers become full (or if the system determines that a given Element 110 was not useful for a given context), the Question Answering System 105 can sink the Element 110 to a relatively lower layer, in order to reduce the probability that it will be used to respond to subsequent Requests 120 with similar contexts (and to make room in higher layers for more relevant data).

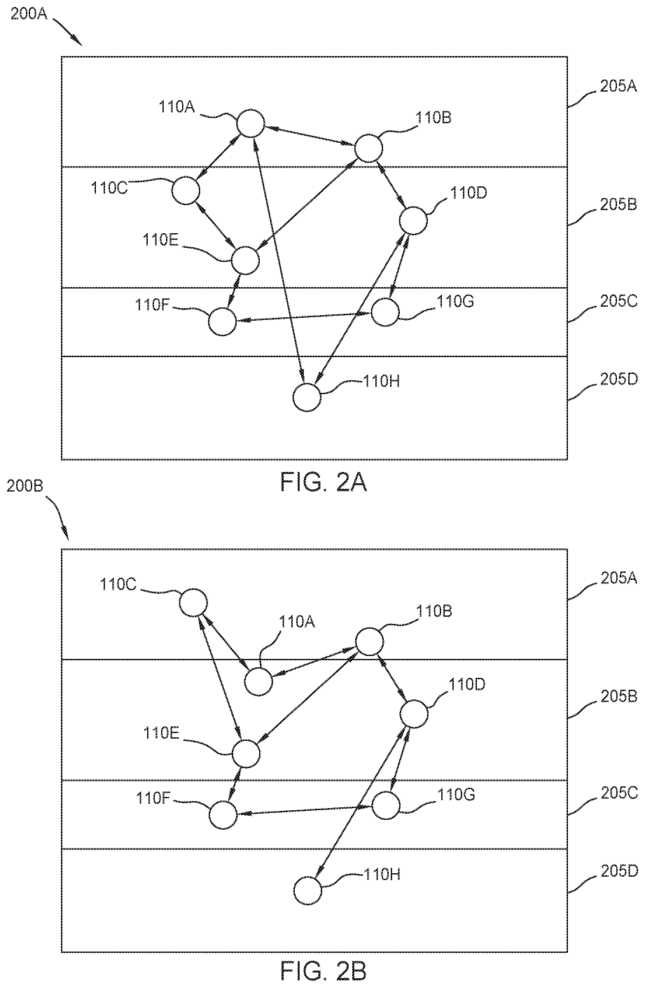

FIGS. 2A and 2B illustrate techniques to surface and sink relevant information segments to improve efficiency, according to one embodiment disclosed herein. In the illustrated embodiment of FIG. 2A, the Information Space is divided into a series of Layers 205A-D. Each layer has respective costs of access. As used herein, a first Layer 205 is considered “relatively higher” than a second Layer 205 if the costs of access are lower for the first Layer 205, as compared to the costs of access of the second Layer 205. The costs of access may include, for example, the latency required to access data stored in the Layer 205, computing resources required to access the data, monetary costs of accessing the data, and the like. Similarly, a first Layer 205 is “relatively lower” than a second Layer 205 if the cost of access for the first Layer 205 is higher than the cost of access for the Second Layer 205.

In embodiments, the storage system can include any number and type of mechanisms, including volatile storage (e.g., caches or RAM) and/or nonvolatile storage (e.g., hard disks). Further, the data can be stored within each Layer 205 in any number of ways. For example, in one Layer 205 the data may be serialized, while it is deserialized in another Layer 205. As illustrated in FIG. 2A, the Elements 110 in the Information Space 200A are distributed across the Layers 205A-D, based at least in part on how useful or relevant they have been in responding to previous requests. For example, the Elements 110A and 110B are located in the highest Layer 205A, which makes them highly accessible to the AI system. This can reduce the costs of accessing them for future requests, as well as increase the probability that they will be retrieved for a request with similar context (e.g., because the system will likely search at least some of the Layer 205A before proceeding to the lower Layers 205).

In embodiments, each Layer 205 can be any size. That is, although lower Layers 205 tend to be larger and able to store larger numbers of Elements 110 (e.g., because the storage is relatively less expensive, monetarily), in some embodiments, one or more relatively higher Layers 205 may have higher capacity than lower Layers 205. For example, although hard disk storage is relatively inexpensive in terms of monetary cost per unit of storage, the system may utilize a significant amount of faster (but more expensive, in terms of monetary cost per unit of storage) storage in a higher Layer 205, in order to improve the operations and latency of the system. The particular size of each Layer 205 can therefore vary in various implementations.

FIG. 2A depicts an Information Space 200A at a first point in time, while FIG. 2B depicts the Information Space 200B at a second moment in time. As illustrated, in the Information Space 200B, the Element 110A has been moved from the highest Layer 205A to a relatively lower Layer 205B, while the Element 110C has been moved from the relatively lower Layer 205B to the highest Layer 205A. Notably, the connections and relationships between Elements 110 are unchanged (e.g., the weights have not changed). In an embodiment, the system may have moved the Element 110C to the highest Layer 205A because it was found to be relevant or useful in answering a recent user request. Similarly, the Element 110A may have been moved to the Layer 205B because it was not as useful, or because the Layer 205A was full.

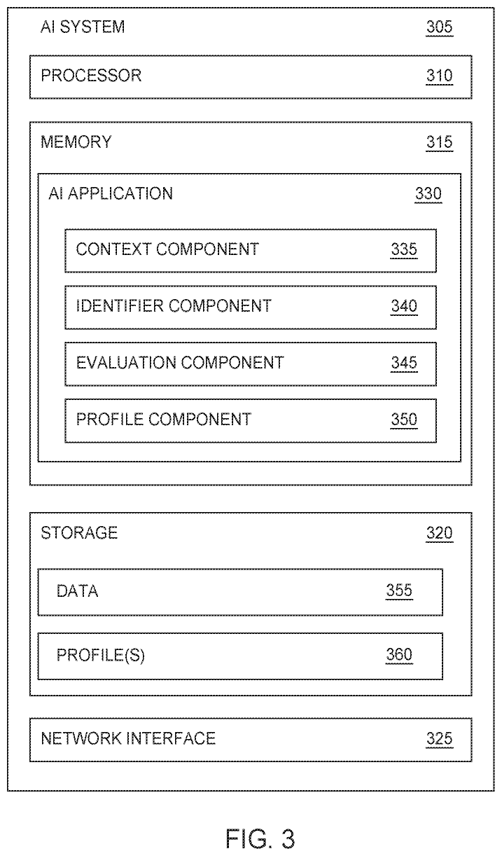

FIG. 3 is a block diagram illustrating an AI System 305 configured to identify relevant information segments using active adaptation based on environmental context, according to one embodiment disclosed herein. Although illustrated as a physical computing system, in embodiments, the AI System 305 may be implemented using hardware or software (e.g., as a virtual computing system), and may be distributed across any number of devices. In the illustrated embodiment, the AI System 305 includes a Processor 310, Memory 315, Storage 320, and a Network Interface 325. In the illustrated embodiment, the Processor 310 retrieves and executes programming instructions stored in Memory 315, as well as stores and retrieves application data residing in Storage 320. The Processor 310 is generally representative of a single CPU, multiple CPUs, a single CPU having multiple processing cores, and the like. The Memory 315 is generally included to be representative of a random access memory. Storage 320 may be any combination of disk drives, flash-based storage devices, and the like, and may include fixed and/or removable storage devices, such as fixed disk drives, removable memory cards, caches, optical storage, network attached storage (NAS), or storage area networks (SAN). In an embodiment, the Storage 320 is a heterogeneous system of layers, where each layer corresponds to a different type of storage and/or storage with a different cost of access. Via the Network Interface 325, the AI System 305 can be communicatively coupled with one or more other devices and components.

In the illustrated embodiment, the Storage 320 includes Data 355 (e.g., Elements 110 arranged in an information graph), as well as one or more Profiles 360. In an embodiment, each Profile 360 specifies a ranking of Elements 110 and/or relationships reflected in the Data 355, in terms of their relevance or importance for a given user and/or context. In one embodiment, the Profiles 360 are scored or evaluated to determine a quality of the profile based on performance indicators (such as the latency or cost of a typical or average response, the confidence associated with a typical response, user feedback regarding the quality of the responses, and the like). Profiles associated with high quality can then be utilized to generate responses for other users, as discussed in more detail below.

As illustrated, the Memory 315 includes an AI Application 330, which includes a Context Component 335, an Identifier Component 340, an Evaluation Component 345, and a Profile Component 350. Although depicted as software residing in Memory 315, in embodiments, the functionality of the AI Application 330 can be implemented using hardware, software, or a combination of hardware and software. Further, although illustrated as discrete components for conceptual clarity, in embodiments, the operations of the Context Component 335, Identifier Component 340, Evaluation Component 345, and Profile Component 350 may be combined or distributed across any number of components. The AI Application 330 generally receives user requests, identifies relevant Data 355, and generates corresponding responses. In some embodiments, the AI Application 330 further manages the storage of the Data 355, such as by actively surfacing (e.g., moving to a relatively higher storage layer) and sinking (e.g., moving to a relatively lower storage layer) data elements based on their relevance or usefulness for the given context.

In an embodiment, the Context Component 335 determines, for each request, the corresponding context. In one embodiment, the context includes the current request, as well as one or more previous requests from the same user. In some embodiments, the context additionally includes one or more previous responses returned by the AI Application 330 to the user. In an embodiment, the context can further include an indication of the user, and/or the corresponding Profile 360. In embodiments, the Context Component 335 can collect and maintain this context as the user interacts with the AI Application 330, in order to generate better responses for the user. For any given request, the Context Component 335 can provide the corresponding context to the Identifier Component 340.

In the illustrated embodiment, the Identifier Component 340 searches the information space (e.g., the Data 355) to identify relevant data or information segments, based on a given context. In one embodiment, the Identifier Component 340 uses natural language processing (NLP) to parse requests in order to determine the intent of the user, and searches the Data 355 for relevant information that can resolve the intent. In embodiments, the Identifier Component 340 searched based at least in part on the current context, and/or the Profile 360 of the user. For example, using the context, the Identifier Component 340 may be able to identify more relevant data (or identify relevant data more quickly). Similarly, using the Profile 360, the Identifier Component 340 can identify data that is more likely to be what the user desires, because the Profile 360 reflects the user's historic interactions with the AI Application 330.

In one embodiment, to retrieve relevant data, the Identifier Component 340 initially searches the highest layer of the Storage 320 to locate elements or entities that may be useful for answering the request. The Identifier Component 340 can then iteratively identify related elements to each originally-identified element (e.g., based on connections in the graph structure). In one embodiment, the Identifier Component 340 passes this data to the Evaluation Component 345 before proceeding. In some embodiments, based on the response of the Evaluation Component 340, the Identifier Component 340 can continue to identify additional elements in a similar manner (following connections in the graph) until a satisfactory answer is generated.

In some embodiments, the Identifier Component 340 retrieves elements from the upper layer until it has exhausted all relevant data in the upper layer, and then proceeds to lower layers. In another embodiment, the Identifier Component 340 uses the layer identity, as well as the relationship strength, to determine whether to retrieve a given element. For example, in such an embodiment, an element with high connection strength to a given element, but found in a lower layer, may be bypassed in favor of a second element in a higher layer, even if the second element has a lower relationship strength or weight. Similarly, in one embodiment, if the connection is sufficiently strong, the Identifier Component 340 can retrieve this data even if it resides in a lower layer of the Storage 320. In one embodiment, the relationship strength between elements is determined based in part on the current context, and/or the current Profile 360.

In the illustrated embodiment, the Evaluation Component 345 evaluates the retrieved data elements in order to determine whether the request can be answered using the data. If a response can be generated with sufficiently-high confidence, the Evaluation Component 345 can instruct the Identifier Component 340 to terminate the search, and the response can be generated and returned. If the retrieved data is still insufficient, the Evaluation Component 345 may instruct the Identifier Component 340 to continue searching. In some embodiments, the Evaluation Component 345 further surfaces and sinks data in the Storage 320 based on its relevance. For example, if a given information segment significantly increases the confidence of the response, the Evaluation Component 345 can move this information segment to a relatively higher layer. In contrast, if a given data element reduces the confidence, the Evaluation Component 345 may sink it to a lower layer in the Storage 320. This reduces the likelihood it will be retrieved in similar contexts in the future.

In an embodiment, the Profile Component 350 builds and maintains profiles for each user. In one embodiment, each Profile 350 includes a ranking of elements and/or relationships between the elements, and each profile is constructed by monitoring the user interactions. For example, if two elements were both used to generate an answer that the user liked, the Profile Component 350 can update the user profile to indicate that the elements are beneficial when combined (e.g., the relationship weight between them should be increased, when generating responses for the user). In some embodiments, as discussed above, the Profile Component 350 further determines performance indicators for each Profile 360, in order to determine a quality of the Profile 360.

For example, the Profile Component 350 can determine how many resources are consumed to generate answers for the user, how accurate or confident the answers are, how the user has rated the answers, and the like. The Profile Component 350 can then continuously merge higher-performing Profiles 360 into the lower-performing profiles, in order to increase the efficiency of the system and guide newer users (e.g., by selecting data that is likely to be relevant, based in part on the high-quality profiles). In this way, in one embodiment, the AI Application 330 can use the rankings specified in higher-performing Profiles 360 when searching for relevant Data 355 and/or when surfacing and sinking Data 355 for other users.

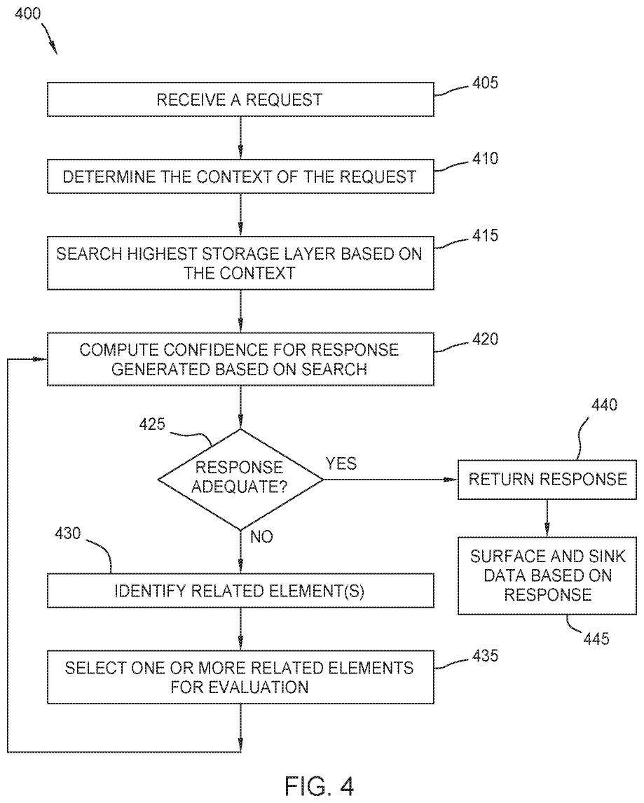

FIG. 4 is a flow diagram illustrating a method 400 for actively identifying relevant information segments, according to one embodiment disclosed herein. The method 400 begins at block 405, where an AI Application 330 receives a request from a user. In an embodiment, the request includes natural language text (or audio which can be converted to text). At block 410, the AI Application 330 determines the current context of the received request. In embodiments, this can include an identity of the requesting user (or a profile of the requesting user), one or more prior requests and/or responses, and the like. The method 400 then proceeds to block 415, where the AI Application 330 searches the highest layer of the storage system based on the determined context. For example, the AI Application 330 may use NLP to determine intent, and search a graph-based information space to identify data elements that may be relevant to the response.

In the illustrated embodiment, the AI Application 330 first searches the highest layer of the storage. That is, because the highest layer has the lowest access cost (e.g., it can be searched quickly), the AI Application 330 first restricts its search to this layer in an effort to reduce latency and computing resources needed to respond to the user. The method 400 then proceeds to block 420, where the AI Application 330 generates a response based on the retrieved data, and computes a confidence in this generated response. In one embodiment, the confidence can be based on the layer(s) in which data was found, based on how well the response fits with the determined intent of the user, and the like. At block 425, the AI Application 330 determines whether the response is adequate (e.g., whether the response satisfies a predefined threshold confidence). If so, the method 400 proceeds to block 440, discussed in more detail below. Otherwise, the method 400 proceeds to block 430.

At block 430, if the response was not yet sufficient, the AI Application 330 identifies related data elements to those that were previously identified and retrieved. In one embodiment, the AI Application 330 does so based in part on the relationships defined in the graph structure, and in part based on the context of the request (e.g., the profile of the user, previous requests, and the like). In embodiments, the identified elements may be located in any layer of the storage system. That is, the previously-identified elements may include pointers to any number of other elements, stored in any number of layers in the system.

The method 400 then continues to block 435, where the AI Application 330 selects one or more of these newly-identified elements to be evaluated. In one embodiment, the AI Application 330 determines whether to retrieve and evaluate a given information segment (e.g., an element in the data) based on the relationship strength and the storage layer in which the segment resides. In such an embodiment, a higher relationship strength is correlated with an increased probability of retrieving the element, and lower storage layers are correlated with lower probability of retrieving the element. In this way, the AI Application 330 can identify and select data that is likely to be more relevant (based on its relationship strength, and further based on the fact that it resides in a relatively higher layer of storage, where more relevant data is maintained). The method 400 then returns to block 420. In this way, the AI Application 330 can iteratively retrieve and evaluate data, reaching deeper into the information space and into lower layers, in order to generate an adequate answer while minimizing needed resources.

Returning to block 440, once a sufficiently adequate answer is generated, the AI Application 330 returns the generated response to the user. The method 400 then proceeds to block 445, where the AI Application 330 manages the storage system by surfacing and/or sinking data elements, based on the generated response. For example, in one embodiment, the AI Application 330 can surface (e.g., move to a relatively higher layer) data elements that were particularly useful or relevant, and sink (e.g., move to a relatively lower layer) data elements that were not useful or that reduced confidence in the response. In some embodiments, the AI Application 330 can receive and utilize feedback from the user in order to refine its models and operations (e.g., to surface and sink data). In this way, the AI Application 330 can better identify relevant data during future operations.

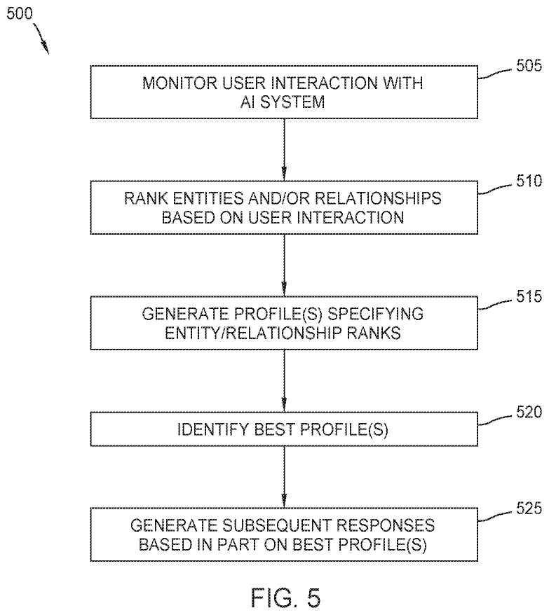

FIG. 5 is a flow diagram illustrating a method 500 for profiling user contexts in an actively-adapting information system, according to one embodiment disclosed herein. The method 500 begins at block 505, where a AI Application 330 monitors as users interact with the AI system (e.g., as they submit requests and receive responses). At block 510, for each user, the AI Application 330 determines rankings of entities (e.g., Elements 110) and/or the relationships between entities, based on the observed user interaction. The AI Application 330 then generates a profile for each user, specifying these rankings. In this way, the AI Application 330 can rely on the previous user interactions, in the form of ranked entities and relationships, when generating subsequent responses for the user.

The method 500 then proceeds to block 520, where the AI Application 330 identifies the top performing profiles. In embodiments, the AI Application 330 can define the best profiles using various key performance indicators (KPIs), such as average latency of a response, average computing cost of generating responses, average accuracy or confidence, and the like. These KPIs are then used to determine the quality of each profile. At block 525, the AI Application 330 generates subsequent responses for one or more users, based on the identified best profiles. For example, in one embodiment, the AI Application 330 merges the best profiles with the profiles of other users (e.g., new users, or users with worse-rated profiles), such as by aggregating or averaging the rankings indicated in each. In this way, responses are generated for these users based, in part, on the top-performing profiles.

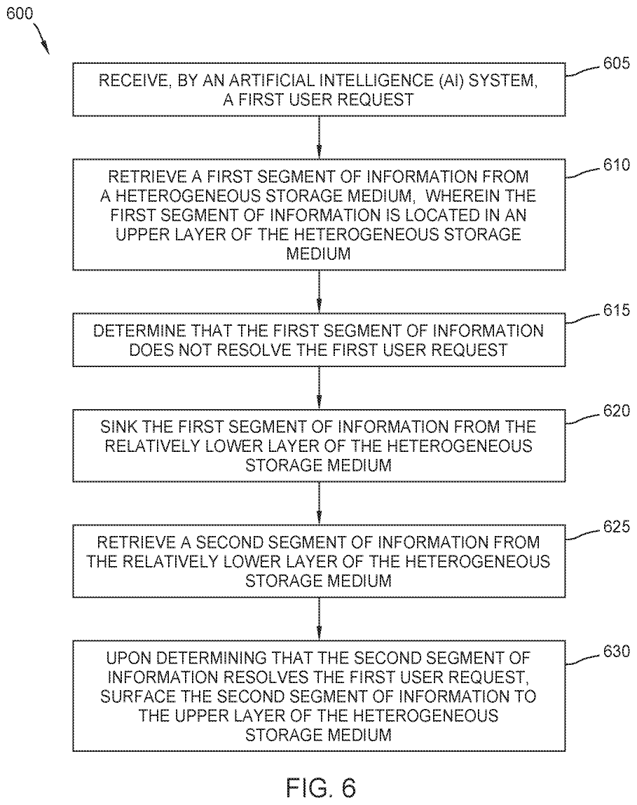

FIG. 6 is a flow diagram illustrating a method 600 for identifying relevant information segments, according to one embodiment disclosed herein. The method 600 begins at block 605, where an AI Application 330 receives a first user request. The method 600 then continues to block 610, where the AI Application 330 retrieves a first segment of information from a heterogeneous storage medium, wherein the first segment of information is located in an upper layer of the heterogeneous storage medium. Further, at block 615, the AI Application 330 determines that the first segment of information does not resolve the first user request. Based on this determination, the method 600 continues to block 620, where the AI Application 330 sinks the first segment of information to a relatively lower layer of the heterogeneous storage medium. Further, at block 625, the AI Application 330 retrieves a second segment of information from the relatively lower layer of the heterogeneous storage medium. The method 600 then proceeds to block 630, where, upon determining that the second segment of information resolves the first user request, the AI Application 330 surfaces the second segment of information to the upper layer of the heterogeneous storage medium.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the invention may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present invention, a user may access applications (e.g., the AI Application 330) or related data available in the cloud. For example, the AI Application 330 could execute on a computing system in the cloud and manage a heterogeneous storage system. In such a case, the AI Application 330 could receive requests and generate responses, storing data elements at various storage layers located in the cloud. Doing so allows a user to access this information from any computing system attached to a network connected to the cloud (e.g., the Internet).

While the foregoing is directed to embodiments of the present invention, other and further embodiments of the invention may be devised without departing from the basic scope thereof, and the scope thereof is determined by the claims that follow.

1. A method comprising:
receiving, by an artificial intelligence (AI) system, a first user request;
retrieving a first segment of information from a heterogeneous storage medium, wherein the first segment of information is located in an upper layer of the heterogeneous storage medium, wherein the first segment of information is part of an information graph that comprises a plurality of segments of information, and wherein information graph further comprises relationship links among the plurality segments of information; and
upon determining that the first segment of information does not resolve the first user request:
sinking the first segment of information to a relatively lower layer of the heterogeneous storage medium;
retrieving a second segment of information from the relatively lower layer of the heterogeneous storage medium based on determining that a first strength of a first relationship link between the first segment of information and the second segment of information exceeds a predefined threshold; and
upon determining that the second segment of information resolves the first user request, surfacing the second segment of information to the upper layer of the heterogeneous storage medium.

2. The method of claim 1, wherein the heterogeneous storage medium comprises a plurality of layers, wherein each of the plurality of layers has a respective access cost.

3. The method of claim 2, wherein the upper layer of the heterogeneous storage medium has a relatively lower access cost than the relatively lower layer of the heterogeneous storage medium.

4. The method of claim 1, the method further comprising determining not to retrieve a third segment of information, wherein a second strength of a second relationship link between the first segment of information and the third segment of information exceeds the first strength, based on determining that the third segment of information is in a relatively lower layer of the heterogeneous storage medium, as compared to the second segment of information.

5. The method of claim 1, wherein the first segment of information is identified based on a first context of the first user request, wherein the first context indicates a first user who made the first user request, as well as one or more previous requests of the first user.

6. The method of claim 5, the method further comprising:
generating a first profile of the first user based on the one or more previous requests of the first user, wherein the first profile specifies a ranking of one or more entities in the first segment of information, as well as corresponding relationships between the one or more entities.

7. The method of claim 6, the method further comprising:
determining one or more performance indicators indicating a quality of the first profile, with respect to the AI system; and
upon determining that the quality of the first profile exceeds a threshold, using the first profile to answer requests for new users of the AI system.

8. The method of claim 1, the method further comprising:
receiving, by the AI system, a second user request, wherein the second user request specifies an allowable cost to answer the second user request;
determining that the second user request cannot be adequately answered using data located in the upper layer of the heterogeneous storage medium; and
based on the specified allowable cost, searching the relatively lower layer of the heterogeneous storage medium.

9. A computer-readable storage medium having computer-readable program code embodied therewith, the computer-readable program code executable by one or more computer processors to perform an operation comprising:
receiving, by an artificial intelligence (AI) system, a first user request;
retrieving a first segment of information from a heterogeneous storage medium, wherein the first segment of information is located in an upper layer of the heterogeneous storage medium, wherein the first segment of information is part of an information graph that comprises a plurality of segments of information, and wherein information graph further comprises relationship links among the plurality segments of information; and
upon determining that the first segment of information does not resolve the first user request:
sinking the first segment of information to a relatively lower layer of the heterogeneous storage medium;
retrieving a second segment of information from the relatively lower layer of the heterogeneous storage medium based on determining that a first strength of a first relationship link between the first segment of information and the second segment of information exceeds a predefined threshold; and
upon determining that the second segment of information resolves the first user request, surfacing the second segment of information to the upper layer of the heterogeneous storage medium.

10. The computer-readable storage medium of claim 9, wherein the heterogeneous storage medium comprises a plurality of layers, wherein each of the plurality of layers has a respective access cost, and wherein the upper layer of the heterogeneous storage medium has a relatively lower access cost than the relatively lower layer of the heterogeneous storage medium.

11. The computer-readable storage medium of claim 9, the method further comprising determining not to retrieve a third segment of information, wherein a second strength of a second relationship link between the first segment of information and the third segment of information exceeds the first strength, based on determining that the third segment of information is in a relatively lower layer of the heterogeneous storage medium, as compared to the second segment of information.

12. The computer-readable storage medium of claim 9, wherein the first segment of information is identified based on a first context of the first user request, wherein the first context indicates a first user who made the first user request, as well as one or more previous requests of the first user.

13. The computer-readable storage medium of claim 12, the operation further comprising:
generating a first profile of the first user based on the one or more previous requests of the first user, wherein the first profile specifies a ranking of one or more entities in the first segment of information, as well as corresponding relationships between the one or more entities
determining one or more performance indicators indicating a quality of the first profile, with respect to the AI system; and
upon determining that the quality of the first profile exceeds a threshold, using the first profile to answer requests for new users of the AI system.

14. The computer-readable storage medium of claim 9, the operation further comprising:
receiving, by the AI system, a second user request, wherein the second user request specifies an allowable cost to answer the second user request;
determining that the second user request cannot be adequately answered using data located in the upper layer of the heterogeneous storage medium; and
based on the specified allowable cost, searching the relatively lower layer of the heterogeneous storage medium.

15. A system comprising:
one or more computer processors; and
a memory containing a program which when executed by the one or more computer processors performs an operation, the operation comprising:
receiving, by an artificial intelligence (AI) system, a first user request;
retrieving a first segment of information from a heterogeneous storage medium, wherein the first segment of information is located in an upper layer of the heterogeneous storage medium, wherein the first segment of information is part of an information graph that comprises a plurality of segments of information, and wherein information graph further comprises relationship links among the plurality segments of information; and
upon determining that the first segment of information does not resolve the first user request:
sinking the first segment of information to a relatively lower layer of the heterogeneous storage medium;
retrieving a second segment of information from the relatively lower layer of the heterogeneous storage medium based on determining that a first strength of a first relationship link between the first segment of information and the second segment of information exceeds a predefined threshold; and
upon determining that the second segment of information resolves the first user request, surfacing the second segment of information to the upper layer of the heterogeneous storage medium.

16. The system of claim 15, wherein the heterogeneous storage medium comprises a plurality of layers, wherein each of the plurality of layers has a respective access cost, and wherein the upper layer of the heterogeneous storage medium has a relatively lower access cost than the relatively lower layer of the heterogeneous storage medium.

17. The system of claim 15, the method further comprising determining not to retrieve a third segment of information, wherein a second strength of a second relationship link between the first segment of information and the third segment of information exceeds the first strength, based on determining that the third segment of information is in a relatively lower layer of the heterogeneous storage medium, as compared to the second segment of information.

18. The system of claim 15, wherein the first segment of information is identified based on a first context of the first user request, wherein the first context indicates a first user who made the first user request, as well as one or more previous requests of the first user.

19. The system of claim 18, the operation further comprising:
generating a first profile of the first user based on the one or more previous requests of the first user, wherein the first profile specifies a ranking of one or more entities in the first segment of information, as well as corresponding relationships between the one or more entities
determining one or more performance indicators indicating a quality of the first profile, with respect to the AI system; and
upon determining that the quality of the first profile exceeds a threshold, using the first profile to answer requests for new users of the AI system.

20. The system of claim 15, the operation further comprising:
receiving, by the AI system, a second user request, wherein the second user request specifies an allowable cost to answer the second user request;
determining that the second user request cannot be adequately answered using data located in the upper layer of the heterogeneous storage medium; and
based on the specified allowable cost, searching the relatively lower layer of the heterogeneous storage medium.
